(19) United States
(12) Patent Application Publication
(10) Pub. No.: US 2015/0139105 A1
(43) Pub. Date: May 21, 2015

(54) Method and device for performing interference measurement on interference measurement resources

(71) Applicant: ZTE Corporation, Shenzhen (CN)

(72) Inventors: Senbao Guo, Shenzhen (CN); Chenchen Zhang, Shenzhen (CN); Yunfeng Sun, Shenzhen (CN); Dongli Chen, Shenzhen (CN)

(21) Appl. No.: 14/405,446

(22) PCT Filed: Jul. 10, 2013
(86) PCT No.: PCT/CN2013/079150

§ 371 Date: Dec. 4, 2014

(30) Foreign Application Priority Data
Aug. 2, 2012 (CN) 201210272492.0

(51) Int. Cl. H04W 24/10; H04W 72/04

(52) U.S. Cl. CPC H04W 24/10; H04W 72/04
USPC 370/329

(57) ABSTRACT

A method and device for performing interference measurement on interference measurement resources are disclosed, in which a base station side transmits N sets of interference measurement resources on a non-full bandwidth or a full bandwidth, and transmits a location indication signaling of each set of the interference measurement resources to a terminal side; the terminal side determines a location of each set of the interference measurement resources according to the location indication signaling of each set of interference measurement resources, and performs interference measurement on each set of interference measurement resources in accordance with the non-full bandwidth or the full bandwidth; through a technical scheme of the disclosure, the interference measurement can be implemented on different interference measurement resources by employing time domain and frequency domain resource overheads and high layer signaling overheads as less as possible.

### TECHNICAL FIELD

The disclosure relates to a Long Term Evolution (LTE) telecommunication technology, and particularly relates to a method and device for performing interference measurement on interference measurement resources.

### BACKGROUND

After developing several versions such as R9/10/11, a LTE system also accurately researches a R12 technique successively. Currently, a part of R8 products begin to be used in business gradually, R9 and R10 remain to be further proceeded with product planning.

After experiencing a R8 phase and a R9 phase, a lot of new characters are further added to the R10 based on the above two, for example a pilot character such as a Demodulation Reference Signal (DMRS), a Channel State Information Reference Signal (CSI-RS) and the like, and a transmission and feedback character such as 8-antenna support and the like, and etc. Specifically, an enhanced Inter-Cell Interference Cancellin (eICIC) technique further considers a technique for avoiding an inter-cell interference based on consideration of R8/9 ICIC. With regard to the technique for solving an inter-cell interference problem, avoiding the inter-cell interference under a homogeneous network, the main consideration of which is the eICIC technique and a Coordinated Multi-point (CoMP) technique, is mainly considered in beginning of a R10 phase. The CoMP is that multiple points coordinate to transmit data to one or more User Equipments (UEs) in the same time frequency resource or different time frequency resources. The CoMP technique can reduce interference between cells, improve a throughput rate of a cell edge, and enlarge cell coverage. However, because in a later period of discussion a heterogeneous network introducing more scenes, complexity of the CoMP technique, and the time limit for the discussion of R10 are considered, it is finally decided that extra CoMP standardization content is not introduced in the R10 phase, but a part of requirements of the CoMP may be considered into design when the CSI-RS is designed, therefore the CoMP technique is not further discussed after a 60 bis conference.

Configuration information of R10 CSI-RS mainly includes a non-zero power CSI-RS configuration signaling and a zero power CSI-RS configuration signaling. Non-zero power CSI-RS configuration mainly considers notifying a terminal side of the time frequency resource location in one subframe of each non-zero power CSI-RS by utilizing a table indexing way, as shown in Table 1 and Table 2, wherein Table 1 provides a resource mapping configured in a normal cyclic prefix subframe by the CSI-RS, Table 2 provides a resource mapping configured in an expanded cyclic prefix subframe by the CSI-RS; the terminal side is notified of the number of the time frequency resources occupied by the non-zero power CSI-RS and a corresponding antenna port through an antenna port number configuration, and a location of a subframe is notified by utilizing a subframe offset and a periodical index to the terminal side to receive the CSI-RS. The CSI-RS subframe configuration is shown in Table 3.

TABLE 1

| | CSI reference | Number of CSI reference signals configured | | | | | |
|---|---|---|---|---|---|---|---|
| | signal | 1 or 2 | | 4 | | 8 | |
| | Configuration | (k′, l′) | nₛ mod 2 | (k′, l′) | nₛ mod 2 | (k′, l′) | nₛ mod 2 |
| Frame structure | 0 | (9, 5) | 0 | (9, 5) | 0 | (9, 5) | 0 |
| type 1 and 2 | 1 | (11, 2) | 1 | (11, 2) | 1 | (11, 2) | 1 |
| | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| Frame structure | 20 | (11, 1) | 1 | (11, 1) | 1 | (11, 1) | 1 |
| type 2 only | 21 | (9, 1) | 1 | (9, 1) | 1 | (9, 1) | 1 |
| | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

TABLE 2

| | CSI reference | Number of CSI reference signals configured | | | | | |
|---|---|---|---|---|---|---|---|
| | signal | 1 or 2 | | 4 | | 8 | |
| | Configuration | (k′, l′) | nₛ mod 2 | (k′, l′) | nₛ mod 2 | (k′, l′) | nₛ mod 2 |
| Frame structure | 0 | (11, 4) | 0 | (11, 4) | 0 | (11, 4) | 0 |
| type 1 and 2 | 1 | (9, 4) | 0 | (9, 4) | 0 | (9, 4) | 0 |
| | 2 | (10, 4) | 1 | (10, 4) | 1 | (10, 4) | 1 |
| | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| Frame structure | 16 | (11, 1) | 1 | (11, 1) | 1 | (11, 1) | 1 |
| type 2 only | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

TABLE 3

| | | CSI-RS |
|---|---|---|
| | CSI-RS | subframe offset |
| CSI-RS- | periodicity T_{CSI-RS} | Δ_{CSI-RS} |
| SubframeConfig I_{CSI-RS} | (subframes) | (subframes) |
| 0-4 | 5 | I_{CSI-RS} |
| 5-14 | 10 | I_{CSI-RS} - 5 |
| 15-34 | 20 | I_{CSI-RS} - 15 |
| 35-74 | 40 | I_{CSI-RS} - 35 |
| 75-154 | 80 | I_{CSI-RS} - 75 |

The zero power CSI-RS utilizes a 16-bit bitmap sequence to notify the terminal side of the need of a rate matched resource element. As shown in Table 3, the periodicity and subframe offset of CSI-RS are used to notify the terminal side of the subframe in which the zero power CSI-RS is located.

The main purpose of the non-zero power CSI-RS is to let the terminal side measure the CSI and send a feedback to a base station side. The purpose of the zero power CSI-RS is mainly to reduce the interference of a data service to the CSI-RS, thus improving accuracy of measurement of the CSI; after the base station side notifies the terminal side of a resource location of the zero power CSI-RS, the terminal side supposes that the base station side does not place a Physical Downlink Shared Channel (PDSCH) or other reference signal or channel in the resource location of the zero power CSI-RS.

R11 needs to consider the influence of the CoMP technique to a standard, and specifically needs to consider the configuration of the interference measurement resources and the configuration of the zero power CSI-RS resources. A latest R11 conference discussed that measuring the interference by utilizing a zero power CSI-RS resource can obtain a more accurate interference estimation performance and can also partially realize compatibility with a R10 version of terminal. After an interference measurement way through the zero power CSI-RS is introduced into the R11 phase, a rate matching resource needed to be identified by the terminal side includes the following three types:

1. Non-zero power CSI-RS resource;

a base station side sends a non-zero power CSI-RS by a 8-port or 4-port way, a terminal side can only support 4 ports or 2 ports to the maximum extent to identify the non-zero power CSI-RS, at this moment it needs to perform rate matching in accordance with the non-zero power CSI-RS at other port location which cannot be identified; or the base station side sends a non-zero power CSI-RS, and the terminal side identifies the non-zero power CSI-RS by employing a feedback mode 1-0, or 2-0, or 3-0, and at this moment the terminal side does not need to configure a port for identifying the non-zero power CSI-RS, and only needs to configure a port for identifying the zero power CSI-RS.

2. Zero power CSI-RS resource which reduces the interference of a data service to CSI-RS measurement;

3. Zero power CSI-RS resource for the terminal side to measure the interference at the corresponding resource location.

With regard to the first and second rate matching resource above, the purposes of the R11 and the R10 to configure the zero power CSI-RS are the same, and the third rate matching resource above is newly added by R11. In this way, R11 needs to present a new zero power CSI-RS configuration way, making the zero power CSI-RS of R11 to at least include two parts, wherein one part is for interference measurement, and another part is for rate matching; however, no interference measurement scheme of the zero power CSI-RS aiming at the interference measurement has been provided until now. In the disclosure, the zero power CSI-RS of the interference measurement is referred to as an Interference Measurement Resource (IMR), and the zero power CSI-RS of rate matching is referred to as a Rate Matching Resource (RMR).

### SUMMARY

In view of this, the purpose of embodiments of the disclosure is to provide a method and device for performing interference measurement on interference measurement resources, which can implement the interference measurement on different interference measurement resources by employing time domain and frequency domain resource overheads and high layer signaling overheads as less as possible.

In order to achieve the above purpose, a technical scheme of an embodiment of the disclosure is implemented hereinafter.

The embodiment of the disclosure provides a method for performing interference measurement on an interference measurement resource, which includes that:

a base station side transmits N sets of interference measurement resources on a non-full bandwidth or a full bandwidth, and transmits a location indication signaling of each set of the interference measurement resources to a terminal side.

In the above scheme, the location indication signaling includes a location identifier; and

the location identifier includes a location identifier of a location of a subband, or a location identifier of a location of a Resource Block Group (RBG), or a location identifier of a location of a Resource Block (RB) occupied by each set of the interference measurement resources.

In the above scheme, before the base station side transmits N sets of interference measurement resources on the non-full bandwidth or the full bandwidth, this method further includes that the base station determines the location identifier according to at least one of the following configuration information: a system bandwidth configuration, a number of the RBs contained in the RBG, the number of the RBs contained in the subband, a transmission mode configuration, a feedback mode configuration, and a feedback type configuration, and determines the location of each set of the interference measurement resources based on the location identifier and at least one of the configuration information; wherein

the system bandwidth configuration, and/or the number of the RB contained in the RBG, and/or the number of the RB contained in the subband, and/or the transmission mode configuration, and/or the feedback mode configuration, and/or the feedback type configuration are notified to the terminal side through a system configuration or a predefined way.

In the above scheme, the location indication signaling includes at least one of the following configuration information: the system bandwidth configuration, the number of the RBs contained in the RBG, the number of the RBs contained in the subband, the transmission mode configuration, the feedback mode configuration, and the feedback type configuration.

In the above scheme, determining the location of each set of the interference measurement resources based on the location identifier and the system bandwidth configuration is that the base station side determines a reuse factor of the interference measurement resources according to the system bandwidth configuration, and determines the location of the RB occupied by each set of the interference measurement resources based on the reuse factor and the location identifier.

In the above scheme, determining the location of each set of the interference measurement resources based on the location identifier, the system bandwidth configuration, and the number of the RBs contained in the RBG is that the base station side determines the number of the RBs occupied in one RBG by the interference measurement resources according to the system bandwidth configuration and the number of the RBs contained in the RBG, and determines the location of the RB occupied by each set of the interference measurement resources based on the number of the RB and the location identifier.

In the above scheme, determining the location of each set of the interference measurement resources based on the location identifier, the system bandwidth configuration, and the number of the RBs contained in the subband is that the base station side determines the number of the RBs occupied in one subband by the interference measurement resources according to the system bandwidth configuration and the number of the RBs contained in the subband, and determines the location of the RB occupied by each set of the interference measurement resources based on the number of the RB and the location identifier.

In the above scheme, determining the location of each set of the interference measurement resources based on the location identifier, and the transmission mode configuration and/or the feedback mode configuration and/or the feedback type configuration is that the base station side determines a distribution way of the interference measurement resources according to the transmission mode configuration, and/or the feedback mode configuration, and/or the feedback type configuration, and determining the location of the RB occupied by each set of the interference measurement resources based on distribution way and the location identifier.

In the above scheme, the location indication signaling is a terminal-specific high layer signaling, and the terminal-specific high layer signaling indicating the location of each set of the interference measurement resources includes that:

the terminal-specific high layer signaling indicates the location of the RB occupied by each set of the interference measurement resources in a bitmapping way, and indicating a cycle and a subframe offset corresponding to the interference measurement in an indexing way;

or the terminal-specific high layer signaling indicates the location of the RB occupied by each set of the interference measurement resources in a resource distributing way of resource distributing type 0, resource distributing type 1, or resource distributing type 2, and indicates the cycle and the subframe offset corresponding to the interference measurement in the indexing way;

or the terminal-specific high layer signaling indicates the location of the subband occupied by each set of the interference measurement resources in the bitmapping way, and indicates the cycle and the subframe offset corresponding to the interference measurement in the indexing way;

or the terminal-specific high layer signaling indicates the location of the subband occupied by each set of the interference measurement resources in the resource distributing way of the resource distributing type 0, the resource distributing type 1, or the resource distributing type 2, and indicates the cycle and the subframe offset corresponding to the interference measurement in the indexing way;

or the terminal-specific high layer signaling indicates the location of the RB occupied by each interference measurement resource, and indicates the cycle and the subframe offset corresponding to the interference measurement in the indexing way, according as the preset location of each interference measurement resource is at an odd RB or at an even RB;

or the terminal-specific high layer signaling indicates the location of the subband occupied by each set of interference measurement resources, and indicates the cycle and the subframe offset corresponding to the interference measurement in the indexing way, according as the preset location of each set of interference measure resources is at an odd subband or at an even subband;

or the terminal-specific high layer signaling indicates the location of the subband occupied by each set of interference measurement resources, and indicates the cycle and the subframe offset corresponding to the interference measurement in the indexing way, according as the preset location of each set of interference measure resources is at an odd subband of an odd subframe, or at an even subband of an even subframe;

or the terminal-specific high layer signaling indicates the location of the RB occupied by each set of interference measurement resources, and indicates the cycle and the subframe offset corresponding to the interference measurement in the indexing way, according as the preset location of each set of interference measure resources is at an odd RB of an odd subframe, or at an even RB of an even subframe.

In the above scheme, the location of the interference measurement resource at least includes one of the followings: the location of the RB occupied by the interference measurement resource, the location of the subband occupied by the interference measurement resource, a time frequency location of the interference measurement resource in one RB, and a subframe location and the cycle of the interference measurement resource.

In the above scheme, this method further includes that the base station side notifies the terminal side through a preset way and/or the terminal-specific high layer signaling that a hopping way is employed to determine the location of the interference measurement resource, and notifies the terminal of the hopping way employed; or

the base station side notifies the terminal side of the location of Physical RB Pairs (PRB Pairs) in which the interference measurement resource is located, through RB indication information in a downlink authorization signaling.

The embodiment of the disclosure provides a method for performing interference measurement on an interference measurement resource, which includes that

a terminal side receives a location indication signaling of each set of interference measurement resources transmitted by a base station side, determines a location of each set of the interference measurement resources according to the location indication signaling of each set of interference measurement resources, and performs interference measurement on each set of interference measurement resources in accordance with a non-full bandwidth or a full bandwidth.

In the above scheme, the location indication signaling includes a location identifier; and

the location identifier includes a location identifier of a location of a subband, or a location identifier of a location of a Resource Block Group (RBG), or a location identifier of a location of a Resource Block (RB) occupied by each set of the interference measurement resources.

In the above scheme, determining by the terminal side the location of each set of the interference measurement resources according to the location indication signaling of each set of the interference measurement resources is that the terminal side determines the location of each set of the interference measurement resources based on the location identifier and at least one of the following configuration information: a system bandwidth configuration, a number of the RB contained in the RBG, the number of the RM contained in the subband, a transmission mode configuration, a feedback mode configuration, and a feedback type configuration;

the system bandwidth configuration, and/or the number of the RB contained in the RBG, and/or the number of the RM contained in the subband, and/or the transmission mode configuration, and/or the feedback mode configuration, and/or the feedback type configuration are obtained by the terminal side through a system configuration or a predetermined way.

In the above scheme, the location indication signaling includes at least one of the following configuration information: the system bandwidth configuration, the number of the RBs contained in the RBG, the number of the RBs contained in the subband, the transmission mode configuration, the feedback mode configuration, the feedback type configuration.

In the above scheme, determining by the terminal side the location of each set of the interference measurement resources based on the location identifier and the system bandwidth configuration is that the terminal side determines a reuse factor of the interference measurement resource according to the system bandwidth configuration, and determines the location of the RB occupied by each set of the interference measurement resources based on the reuse factor and the location identifier in the location indication signaling.

In the above scheme, determining by the terminal side the location of each set of the interference measurement resources based on the location identifier, the system bandwidth configuration, and the number of the RBs contained in the RBG is that the terminal side determines the number of the RBs occupied in one RBG by the interference measurement resource according to the system bandwidth configuration and the number of the RBs contained in the RBG, and determines the location of the RB occupied by each set of the interference measurement resources based on the number of the RB and the location identifier in the location indication signaling.

In the above scheme, determining by the terminal side the location of each set of the interference measurement resources based on the location identifier, the system bandwidth configuration, and the number of the RBs contained in the subband is that the terminal side determines the number of the RBs occupied in one subband by the interference measurement resource according to the system bandwidth configuration and the number of the RBs contained in the subband, and determines the location of the RB occupied by each set of the interference measurement resources based on the number of the RBs and the location identifier in the location indication signaling.

In the above scheme, determining by the terminal side the location of each interference measurement resources based on the location identifier, and the transmission mode configuration and/or the feedback mode configuration and/or the feedback type configuration is that the terminal side determines a distribution way of the interference measurement resources according to the transmission mode configuration and/or the feedback mode configuration and/or the feedback type configuration, and determining the location of the RB occupied by each set of the interference measurement resources based on the distribution way and the location identifier.

In the above scheme, the location indication signaling is a terminal-specific high layer signaling, and the terminal side determines the location of each set of the interference measurement resources in accordance with an indication of the terminal-specific high layer signaling;

the indication of the terminal-specific high layer signaling includes:

indicating the location of the RB occupied by each set of the interference measurement resources in a bitmapping way, and indicating a cycle and a subframe offset corresponding to the interference measurement in an indexing way;

or indicating the location of the RB occupied by each set of the interference measurement resources in a resource distributing way of resource distributing type 0, resource distributing type 1, or resource distributing type 2, and indicating the cycle and the subframe offset corresponding to the interference measurement in the indexing way;

or indicating the location of the subband occupied by each set of the interference measurement resources in the bitmapping way, and indicating the cycle and the subframe offset corresponding to the interference measurement in the indexing way;

or indicating the location of the subband occupied by each set of the interference measurement resources in the resource distributing way of the resource distributing type 0, the resource distributing type 1, or the resource distributing type 2, and indicating the cycle and the subframe offset corresponding to the interference measurement in the indexing way;

or indicating the location of the RB occupied by each interference measurement resource, and indicating the cycle and the subframe offset corresponding to the interference measurement in the indexing way, according as the preset location of each interference measurement resource is at an odd RB or at an even RB;

or indicating the location of the subband occupied by each interference measurement resource, and indicating the cycle and the subframe offset corresponding to the interference measurement in the indexing way, according as the preset location of each interference measure resource is at an odd subband or at an even subband;

or indicating the location of the subband occupied by each interference measurement resource, and indicating the cycle and the subframe offset corresponding to the interference measurement in the indexing way, according as the preset location of each interference measure resource is at an odd subband of an odd subframe, or at an even subband of an even subframe;

or indicating the location of the RB occupied by each interference measurement resource, and indicating the cycle and the subframe offset corresponding to the interference measurement in the indexing way, according as the preset location of each interference measure resource is at an odd RB of an odd subframe, or at an even RB of an even subframe.

In the above scheme, the location of the interference measurement resource at least includes one of the followings: the location of the RB occupied by the interference measurement resource, the location of the subband occupied by the interference measurement resource, a time frequency location of the interference measurement resource in one RB, and a subframe location and the cycle of the interference measurement resource.

In the above scheme, this method further includes that the terminal side learns that a hopping way is employed to determine the location of the interference measurement resource and the employed hopping way through a preset way and/or by receiving the terminal-specific high layer signaling, and searches out the interference measurement resource in accordance with the hopping way, and performs the interference measurement on the interference measurement resource; or

the terminal side obtains the location of physical RB pairs in which the interference measurement resource is located, through RB indication information in a downlink authorization signaling.

The embodiment of the disclosure provides a base station side, which includes an interference measurement resource transmitting module and a location indication signaling transmitting module; wherein

the interference measurement resource transmitting module is configured to transmit N sets of interference measurement resources on a non-full bandwidth or a full bandwidth; and

the location indication signaling transmitting module is configured to transmit a location indication signaling of each set of interference measurement resources to a terminal side.

In the above scheme, the location indication signaling includes a location identifier;

the location identifier includes a location identifier of a location of a subband, or a location identifier of a location of a Resource Block Group (RBG), or a location identifier of a location of a Resource Block (RB) occupied by each set of the interference measurement resources.

In the above scheme, the location indication signaling further includes at least one of the following configuration information: a system bandwidth configuration, a number of the RB contained in the RBG, the number of the RB contained in the subband, a transmission mode configuration, a feedback mode configuration, and a feedback type configuration.

In the above scheme, the interference measurement resource transmitting module is further configured to determine the location identifier according to at least one of the following configuration information: the system bandwidth configuration, the number of the RB contained in the RBG, the number of the RB contained in the subband, the transmission mode configuration, the feedback mode configuration, and the feedback type configuration, and to determine the location of each set of interference measurement resources based on the location identifier and the at least one of the configuration information.

In the above scheme, the interference measurement resource transmitting module is configured to determine a reuse factor of the interference measurement resources according to the system bandwidth configuration, and to determine the location of the RB occupied by each set of the interference measurement resources based on the reuse factor and the location identifier.

In the above scheme, the interference measurement resource transmitting module is configured to determine the number of the RBs occupied in one RBG by the interference measurement resource according to the system bandwidth configuration and the number of the RBs contained in the RBG, and to determine the location of the RB occupied by each set of the interference measurement resources based on the number of the RB and the location identifier.

In the above scheme, the interference measurement resource transmitting module is configured to determine the number of the RBs occupied in one subband by the interference measurement resources according to the system bandwidth configuration and the number of the RBs contained in the subband, and to determine the location of the RB occupied by each set of the interference measurement resources based on the number of the RBs and the location identifier.

In the above scheme, the interference measurement resource transmitting module is configured to determine a distribution way of the interference measurement resources according to the transmission mode configuration, and/or the feedback mode configuration, and/or the feedback type configuration, and to determine the location of the RB occupied by each set of the interference measurement resources based on distribution way and the location identifier.

In the above scheme, the location indication signaling is a terminal-specific high layer signaling, and indicating by the terminal-specific high layer signaling the location of each set of the interference measurement resources, includes:

indicating, by the terminal-specific high layer signaling, the location of the RB occupied by each set of the interference measurement resources in a bitmapping way, and indicating a cycle and a subframe offset corresponding to the interference measurement in an indexing way;

or indicating, by the terminal-specific high layer signaling, the location of the RB occupied by each set of the interference measurement resources in a resource distributing way of resource distributing type 0, resource distributing type 1, or resource distributing type 2, and indicating the cycle and the subframe offset corresponding to the interference measurement in the indexing way;

or indicating, by the terminal-specific high layer signaling, the location of the subband occupied by each set of the interference measurement resources in the bitmapping way, and indicating the cycle and the subframe offset corresponding to the interference measurement in the indexing way;

or indicating, by the terminal-specific high layer signaling, the location of the subband occupied by each set of the interference measurement resources in the resource distributing way of the resource distributing type 0, the resource distributing type 1, or the resource distributing type 2, and indicating the cycle and the subframe offset corresponding to the interference measurement in the indexing way;

or indicating, by the terminal-specific high layer signaling, the location of the RB occupied by each interference measurement resource, and indicating the cycle and the subframe offset corresponding to the interference measurement in the indexing way, according as the preset location of each interference measurement resource is at an odd RB or at an even RB;

or indicating, by the terminal-specific high layer signaling, the location of the subband occupied by each interference measurement resource, and indicating the cycle and the subframe offset corresponding to the interference measurement in the indexing way, according as the preset location of each interference measure resource is at an odd subband or at an even subband;

or indicating, by the terminal-specific high layer signaling, the location of the subband occupied by each interference measurement resource, and indicating the cycle and the subframe offset corresponding to the interference measurement in the indexing way, according as the preset location of each interference measure resource is at an odd subband of an odd subframe, or at an even subband of an even subframe;

or indicating, by the terminal-specific high layer signaling, the location of the RB occupied by each interference measurement resource, and indicating the cycle and the subframe offset corresponding to the interference measurement in the indexing way, according as the preset location of each interference measure resource is at an odd RB of an odd subframe, or at an even RB of an even subframe.

In the above scheme, the base station side further includes a notifying module configured to notify the terminal side that a hopping way is employed to determine the location of the interference measurement resource through a preset way and/or the terminal-specific high layer signaling, and to notify the terminal side of the hopping way employed; or

the notifying module configured to notify the terminal side of the location of physical RB pairs in which the interference measurement resource is located, through RB indication information in a downlink authorization signaling.

The embodiment of the disclosure provides a terminal side, which includes a location determining module and an interference measurement module; wherein

the location determining module is configured to receive a location indication signaling of each set of interference measurement resources sent by a base station side, and to determine a location of each set of the interference measurement resources according to the location indication signaling of each set of the interference measurement resources;

the interference measurement module is configured to perform interference measurement on each set of the interference measurement resources according as a non-full bandwidth or a full bandwidth.

In the above scheme, the location indication signaling includes a location identifier; and

the location identifier includes a location identifier of a location of a subband, or a location identifier of a location of a Resource Block Group (RBG), or a location identifier of a location of a Resource Block (RB) occupied by each set of the interference measurement resources.

In the above scheme, the location determining module is further configured to determine the location of each set of the interference measurement resources based on the location identifier and at least one of the following configuration information: a system bandwidth configuration, a number of the RBs contained in the RBG, the number of the RBs contained in the subband, a transmission mode configuration, a feedback mode configuration, and a feedback type configuration

In the above scheme, the location determining module is configured to determine a reuse factor of the interference measurement resources according to the system bandwidth configuration, and to determine the location of the RB occupied by each set of the interference measurement resources based on the reuse factor and the location identifier in the location indication signaling.

In the above scheme, the location determining module is configured to determine the number of the RBs occupied in one RBG by the interference measurement resource according to the system bandwidth configuration and the number of the RBs contained in the RBG, and to determine the location of the RB occupied by each set of the interference measurement resources based on the number of the RBs and the location identifier in the location indication signaling.

In the above scheme, the location determine module is configured to determine the number of the RBs occupied in one subband by the interference measurement resource according to the system bandwidth configuration and the number of the RBs contained in the subband, and to determine the location of the RB occupied by each set of the interference measurement resources based on the number of the RBs and the location identifier in the location indication signaling.

In the above scheme, the location determining module is configured to determine a distributing way of the interference measurement resources according to the transmission mode configuration, and/or the feedback mode configuration, and/or the feedback type configuration, and to determine the location of the RB occupied by each set of the interference measurement resources based on the distributing way and the location identifier.

In the above scheme, the location indication signaling is a terminal-specific high layer signaling, the location determining module is configured to determine the location of each set of the interference measurement resources in accordance with an indication of the terminal-specific high layer signaling;

the indication of the terminal-specific high layer signaling includes:

indicating the location of the RB occupied by each set of the interference measurement resources in a bitmapping way, and indicating a cycle and a subframe offset corresponding to the interference measurement in an indexing way;

or indicating the location of the RB occupied by each set of the interference measurement resources in a resource distributing way of resource distributing type 0, resource distributing type 1, or resource distributing type 2, and indicating the cycle and the subframe offset corresponding to the interference measurement in the indexing way;

or indicating the location of the subband occupied by each set of the interference measurement resources in the bitmapping way, and indicating the cycle and the subframe offset corresponding to the interference measurement in the indexing way;

or indicating the location of the subband occupied by each set of the interference measurement resources in the resource distributing way of the resource distributing type 0, the resource distributing type 1, or the resource distributing type 2, and indicating the cycle and the subframe offset corresponding to the interference measurement in the indexing way;

or indicating the location of the RB occupied by each interference measurement resource, and indicating the cycle and the subframe offset corresponding to the interference measurement in the indexing way, according as the preset location of each interference measurement resource is at an odd RB or an even RB;

or indicating the location of the subband occupied by each interference measurement resource, and indicating the cycle and the subframe offset corresponding to the interference measurement in the indexing way, according as the preset location of each interference measure resource is at an odd subband or an even subband;

or indicating the location of the subband occupied by each interference measurement resource and indicating the cycle and the subframe offset corresponding to the interference measurement in the indexing way, according as the preset location of each interference measure resource is at an odd subband of an odd subframe, or at an even subband of an even subframe;

or indicating the location of the RB occupied by each interference measurement resource, and indicating the cycle and the subframe offset corresponding to the interference measurement in the indexing way, according as the preset location of each interference measure resource is at an odd RB of an odd subframe, or at an even RB of an even subframe.

In the above scheme, the location of the interference measurement resource at least includes one of the followings: the location of the RB occupied by the interference measurement resource, the location of the subband occupied by the interference measurement resource, a time frequency location of the interference measurement resource in one RB, and a subframe location and the cycle of the interference measurement resource.

In the above scheme, the location determining module is further configured to search out the interference measurement resource in accordance with a hopping way notified by a base station side; or the location determining module is further configured to obtain the location of physical RB pairs in which the interference measurement resource is located, by detecting RB indication information in a downlink authorization signaling.

The embodiment of the disclosure provides a method and device for performing interference measurement on interference measurement resources, in which a base station side transmits N sets of interference measurement resources on a non-full bandwidth or a full bandwidth, and transmits a location indication signaling of each set of the interference measurement resources to a terminal side; the terminal side determines a location of each set of the interference measurement resources according to the location indication signaling of each set of interference measurement resources, and performs interference measurement on each set of interference measurement resources according as the non-full bandwidth or the full bandwidth; in this way, the interference measurement can be implemented on different interference measurement resources by employing domain and frequency domain resource overheads and high layer signaling overheads as less time as possible.

### BRIEF DESCRIPTION OF THE DRAWINGS

FIG. 1 is a structural schematic diagram of a system for performing interference measurement on an interference measurement resource, which is implemented by an embodiment of the disclosure.

### DETAILED DESCRIPTION

In an embodiment of the disclosure, a base station side transmits N (N≧1) sets of interference measurement resources on a non-full bandwidth or a full bandwidth, and transmits a location indication signaling of each set of the interference measurement resources to a terminal side; the terminal side determines a location of each set of the interference measurement resources according to the location indication signaling of each set of interference measurement resources, and performs interference measurement on each set of interference measurement resources in with the case of the non-full bandwidth or the full bandwidth.

The embodiment of the disclosure is further described in detail below through appended drawings and the specific embodiment.

The embodiment of the disclosure implements a method for performing interference measurement on an interference measurement resource, which includes that a base station side transmits N sets of interference measurement resources on a non-full bandwidth or a full bandwidth, and transmits a location indication signaling of each set of the interference measurement resources to a terminal side.

The non-full bandwidth generally refers to a part of frequency domain resources.

The location indication signaling includes a location identifier.

The location identifier includes a location identifier of a location of a sub band, or a location identifier of a location of a resource block group (RBG), or a location identifier of a location of a resource block (RB) occupied by each set of the interference measurement resources.

The location indication signaling may further include at least one of the following configuration information: a system bandwidth configuration, the number of the RBs contained in the RBG, the number of the RBs contained in the sub band, a transmission mode configuration, a feedback mode configuration, and a feedback type configuration.

For example, the location indication signaling further includes the system bandwidth configuration; the base station side selects a location identifier corresponding to the size of a reuse factor to indicate the location of the RB occupied by each set of the interference measurement resources, according to the reuse factor of the interference measurement resource corresponding to the system bandwidth configuration.

The location indication signaling further includes the system bandwidth configuration and the number of the RBs contained in the RBG; the base station side selects a location identifier corresponding to the number of the RBs to indicate the location of the RB occupied by each set of the interference measurement resources, according to the system bandwidth configuration and the number of the RBs that can be occupied in one RBG by the interference measurement resource corresponding to the number of the RBs contained in the RBG.

The location indication signaling further includes the system bandwidth configuration and the number of the RBs contained in the sub band; the base station side selects a location identifier corresponding to the number of the RBs to indicate the location of the RB occupied by each set of the interference measurement resources, according to the system bandwidth configuration and the number of the RBs that can be occupied in one sub band by the interference measurement resource corresponding to the number of the RBs contained in the sub band.

The location indication signaling further includes the transmission mode configuration, and/or the feedback mode configuration, and/or the feedback type configuration; the base station side indicates a distributing way of a corresponding interference measurement resource, and selects a location identifier corresponding to the distributing way to indicate the location of the RB occupied by each set of the interference measurement resources, according to the transmission mode configuration, and/or the feedback mode configuration, and/or the feedback type configuration.

In this step, the location identifier may be 1 bit or 2 bits and etc.

Before the base station side transmits N sets of interference measurement resources on the non-full bandwidth or the full bandwidth, this method further includes that the base station side determines a location identifier according to at least one of the following configuration information: a system bandwidth configuration, the number of the RBs contained in the RBG, the number of the RBs contained in the sub band, a transmission mode configuration, a feedback mode configuration, and a feedback type configuration, and determines the location of each set of the interference measurement resources based on the location identifier in combination with at least one configuration information.

The system bandwidth configuration, and/or the number of the RBs contained in the RBG, and/or the number of the RBs contained in the sub band, and/or the transmission mode configuration, and/or the feedback mode configuration, and/or the feedback type configuration are notified to the terminal side through a system configuration or a predefined way.

The base station side determines a reuse factor of the interference measurement resource according to the system bandwidth configuration, and determines the location of the RB occupied by each set of the interference measurement resources based on the reuse factor and the location identifier; or

the base station side determines the number of the RBs which can be occupied in one RBG by the interference measurement resource according to the system bandwidth configuration and the number of the RBs contained in the RBG, and determines the location of the RB occupied by each set of the interference measurement resources based on the number of the RB and the location identifier; or

the base station side determines the number of the RBs occupied in one subband by the interference measurement resource according to the system bandwidth configuration and the number of the RBs contained in the sub band, and determines the location of the RBs that can be occupied by each set of the interference measurement resources based on the number of the RBs and the location identifier; or

the base station side determines a distribution way of the interference measurement resource according to the transmission mode configuration, and/or the feedback mode configuration, and/or the feedback type configuration, and determines the location of the RB occupied by each set of the interference measurement resources based on distribution way and the location identifier.

The location indication signaling may be a terminal-specific high layer signaling, and the terminal-specific high layer signaling indicating the location of each set of the interference measurement resources includes:

the terminal-specific high layer signaling indicates the location of the RB occupied by each set of the interference measurement resources in a bitmapping way, and indicates the cycle and the subframe offset corresponding to the interference measurement in an indexing way; or

the terminal-specific high layer signaling indicates the location of the RB occupied by each set of the interference measurement resources in a resource distributing way of the resource distributing type 0, resource distributing type 1, or resource distributing type 2, and indicates the cycle and the subframe offset corresponding to the interference measurement in an indexing way; or

the terminal-specific high layer signaling indicates the location of the sub band occupied by each set of the interference measurement resources in a bitmapping way, and indicates the cycle and the subframe offset corresponding to the interference measurement in an indexing way; or

the terminal-specific high layer signaling indicates the location of the subband occupied by each set of the interference measurement resources in a resource distributing way of the resource distributing type 0, resource distributing type 1, or resource distributing type 2, and indicates the cycle and the subframe offset corresponding to the interference measurement in an indexing way; or

the terminal-specific high layer signaling indicates the location of the RB occupied by each interference measurement resource, and indicates the cycle and the subframe offset corresponding to the interference measurement in an indexing way, according as the preset location of each interference measurement resource is at an odd RB or at an even RB; or

the terminal-specific high layer signaling indicates the location of the sub band occupied by each interference measurement resource, and indicates the cycle and the subframe offset corresponding to the interference measurement in an indexing way, according as the preset location of each interference measure resource is at an odd subband or at an even subband; or

the terminal-specific high layer signaling indicates the location of the subband occupied by each interference measurement resource, and indicates the cycle and the subframe offset corresponding to the interference measurement in an indexing way, according as the preset location of each interference measure resource is at an odd subband of a odd subframe or at an even subband of an even subframe; or

the terminal-specific high layer signaling indicates the location of the RB occupied by each interference measurement resource, and indicates the cycle and the subframe offset corresponding to the interference measurement in an indexing way, according as the preset location of each interference measure resource is at an odd RB of an odd subframe or at an even RB of an even subframe.

The above method further includes that the base station side notifies the terminal side through a preset way and/or the terminal-specific high layer signaling that a hopping way is employed to determine the location of the interference measurement resource, and notifies the terminal side of the employed hopping way; or

the base station side notifies the terminal of the location of Physical RB Pairs (PRB Pairs) in which the interference measurement resource is located, through RB indication information in a downlink authorization signaling.

Based on the above method, the embodiment of the disclosure further provides a method for performing interference measurement on an interference measurement resource, which includes that a terminal side receives a location indication signaling of each set of interference measurement resources transmitted by a base station side, determines a location of each set of the interference measurement resources according to the location indication signaling of each set of interference measurement resources, and performs interference measurement on each set of interference measurement resources according as a non-full bandwidth or a full bandwidth.

The location indication signaling includes a location identifier; and

the location identifier includes a location identifier of a subband, or a location identifier of a RBG, or a location identifier of a location of a RB occupied by each set of the interference measurement resources.

the terminal side determining the location of each set of the interference measurement resources according to the location indication signaling of each set of the interference measurement resources is that the terminal side determines the location of each set of the interference measurement resources based on the location identifier and at least one of the following configuration information: a system bandwidth configuration, the number of the RBs contained in the RBG, the number of the RBs contained in the subband, a transmission mode configuration, a feedback mode configuration, and a feedback type configuration;

here, the system bandwidth configuration, and/or the number of the RBs contained in the RBG, and/or the number of the RBs contained in the subband, and/or the transmission mode configuration, and/or the feedback mode configuration, and/or the feedback type configuration are obtained by the terminal side through a system configuration or a predetermined way.

The location indication signaling includes at least one of the following configuration information: the system bandwidth configuration, the number of the RBs contained in the RBG, the number of the RBs contained in the subband, the transmission mode configuration, the feedback mode configuration, the feedback type configuration.

In the above method, the terminal side determines a reuse factor of the interference measurement resource according to the system bandwidth configuration, and determines the location of the RB occupied by each set of the interference measurement resources based on the reuse factor and the location identifier in the location indication signaling; or

the terminal side determines the number of the RBs that can be occupied in one RBG by the interference measurement resource according to the system bandwidth configuration and the number of the RBs contained in the RBG, and determines the location of the RB occupied by each set of the interference measurement resources based on the number of the RBs and the location identifier in the location indication signaling; or

the terminal side determines the number of the RBs that can be occupied in one subband by the interference measurement resource according to the system bandwidth configuration and the number of the RBs contained in the subband, and determines the location of the RB occupied by each set of the interference measurement resources based on the number of the RBs and the location identifier in the location indication signaling; or

the terminal side determines a distribution way of the interference measurement resources according to the transmission mode configuration and/or the feedback mode configuration and/or the feedback type configuration, and determines the location of the RB occupied by each set of the interference measurement resources based on the distribution way and the location identifier.

The location indication signaling may also be a terminal-specific high layer signaling, and the terminal side determines the location of each set of the interference measurement resources in accordance with an indication of the terminal-specific high layer signaling.

The indication of the terminal-specific high layer signaling includes:

indicating the location of the RB occupied by each set of the interference measurement resources in a bitmapping way, and indicating a cycle and a subframe offset corresponding to the interference measurement in an indexing way;

or indicating the location of the RB occupied by each set of the interference measurement resources in a resource distributing way of a resource distributing type 0, resource distributing type 1 or resource distributing type 2, and indicating the cycle and the subframe offset corresponding to the interference measurement in the indexing way;

or indicating the location of the subband occupied by each set of the interference measurement resources in a bitmapping way, and indicating the cycle and the subframe offset corresponding to the interference measurement in an indexing way;

or indicating the location of the subband occupied by each set of the interference measurement resources in a resource distributing way of the resource distributing type 0, the resource distributing type 1 or the resource distributing type 2, and indicating the cycle and the subframe offset corresponding to the interference measurement in an indexing way;

or indicating the location of the RB occupied by each interference measurement resource, and indicating the cycle and the subframe offset corresponding to the interference measurement in an indexing way, according as the preset location of each interference measurement resource is at an odd RB or even RB;

or indicating the location of the subband occupied by each interference measurement resource, and indicating the cycle and the subframe offset corresponding to the interference measurement in an indexing way, according as the preset location of each interference measure resource is at an odd subband or at an even subband;

or indicating the location of the subband occupied by each interference measurement resource, and indicating the cycle and the subframe offset corresponding to the interference measurement in an indexing way, according as the preset location of each interference measure resource is at an odd subband of an odd subframe, or at an even subband of an even subframe;

or indicating the location of the RB occupied by each interference measurement resource, and indicating the cycle and the subframe offset corresponding to the interference measurement in an indexing way, according as the preset location of each interference measure resource is at an odd RB of an odd subframe, or at an even RB of an even subframe.

Here, the location of the interference measurement resource at least includes one of the following: the location of the RB occupied by the interference measurement resource, the location of the subband occupied by the interference measurement resource, a time frequency location of the interference measurement resource in one RB, and a subframe location and the cycle of the interference measurement resource.

The above method further includes that the terminal side learns that a hopping way is employed to determine the location of the interference measurement resource and the employed hopping way through a preset way and/or by receiving the terminal-specific high layer signaling, and finds the interference measurement resource in accordance with the hopping way, and performs the interference measurement on the interference measurement resource; or

the terminal side obtains the location of a physical RB pair in which the interference measurement resource is located, through RB indication information in a downlink authorization signaling.

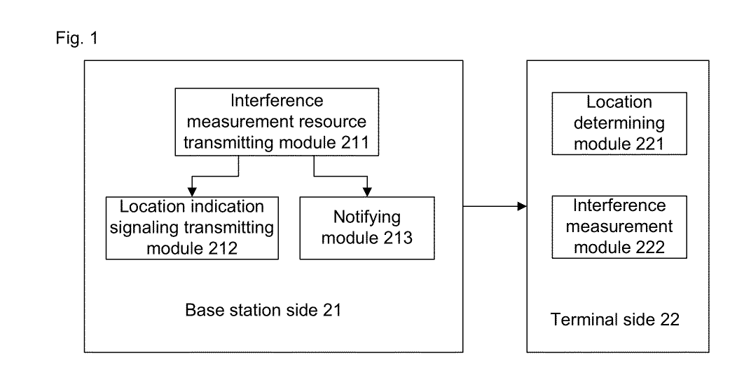

In order to implement the above method, the embodiment of the disclosure also provides a base station side 21, as shown in FIG. 1, which includes an interference measurement resource transmitting module 211 and a location indication signaling transmitting module 212; wherein

the interference measurement resource transmitting module 211 is configured to transmit N sets of interference measurement resources on a non-full bandwidth or a full bandwidth; and

the location indication signaling transmitting module 212 is configured to transmit a location indication signaling of each set of interference measurement resources to a terminal side; and

the non-full bandwidth generally refers to a part of the frequency domain resources.

The location indication signaling includes a location identifier;

the location identifier includes a location identifier of a location of a subband, or a location identifier of a location of a RBG, or a location identifier of a location of a RB occupied by each set of the interference measurement resources.

The location indication signaling may further include at least one of the following configuration information: a system bandwidth configuration, the number of the RBs contained in the RBG, the number of the RBs contained in the subband, a transmission mode configuration, a feedback mode configuration, and a feedback type configuration.

The interference measurement resource transmitting module 211 is further configured to determine the location identifier according to at least one of the following configuration information: the system bandwidth configuration, the number of the RBs contained in the RBG, the number of the RBs contained in the subband, the transmission mode configuration, the feedback mode configuration, and the feedback type configuration; and to determine the location of each set of interference measurement resources based on the location identifier and at least one of the above configuration information.

The interference measurement resource transmitting module 211 is specifically configured to determine a reuse factor of the interference measurement resource according to the system bandwidth configuration, and to determine the location of the RB occupied by each set of the interference measurement resources based on the reuse factor and the location identifier.

The interference measurement resource transmitting module 211 is specifically configured to determine the number of the RBs that can be occupied in one RBG by the interference measurement resource according to the system bandwidth configuration and the number of the RBs contained in the RBG, and to determine the location of the RB occupied by each set of the interference measurement resources based on the number of the RBs and the location identifier.

The interference measurement resource transmitting module 211 is specifically configured to determine the number of the RBs that can be occupied in one subband by the interference measurement resource according to the system bandwidth configuration and the number of the RBs contained in the subband, and to determine the location of the RB occupied by each set of the interference measurement resources based on the number of the RBs and the location identifier.

The interference measurement resource transmitting module 211 is specifically configured to determine a distribution way of the interference measurement resource according to the transmission mode configuration, and/or the feedback mode configuration, and/or the feedback type configuration, and to determine the location of the RB occupied by each set of the interference measurement resources based on the distribution way and the location identifier.

The location indication signaling may also be a terminal-specific high layer signaling, and the terminal-specific high layer signaling indicating the location of each set of the interference measurement resources includes that:

the terminal-specific high layer signaling indicates the location of the RB occupied by each set of the interference measurement resources in a bitmapping way, and indicates the cycle and the subframe offset corresponding to the interference measurement in an indexing way; or

the terminal-specific high layer signaling indicates the location of the RB occupied by each set of the interference measurement resources in the resource distributing way of the resource distributing type 0, the resource distributing type 1, or the resource distributing type 2, and indicates the cycle and the subframe offset corresponding to the interference measurement in an indexing way; or

the terminal-specific high layer signaling indicates the location of the subband occupied by each set of the interference measurement resources in a bitmapping way, and indicates the cycle and the subframe offset corresponding to the interference measurement in an indexing way; or

the terminal-specific high layer signaling indicates the location of the subband occupied by each set of the interference measurement resources in a resource distributing way of the resource distributing type 0, the resource distributing type 1, or the resource distributing type 2, and indicates the cycle and the subframe offset corresponding to the interference measurement in an indexing way; or

the terminal-specific high layer signaling indicates the location of the RB occupied by each interference measurement resource, and indicates the cycle and the subframe offset corresponding to the interference measurement in an indexing way, according as the preset location of each interference measurement resource is at an odd RB or even RB; or

the terminal-specific high layer signaling indicates the location of the subband occupied by each interference measurement resource, and indicates the cycle and the subframe offset corresponding to the interference measurement in an indexing way, according as the preset location of each interference measure resource is at an odd subband or even subband; or

the terminal-specific high layer signaling indicates the location of the subband occupied by each interference measurement resource, and indicates the cycle and the subframe offset corresponding to the interference measurement in an indexing way, according as the preset location of each interference measure resource is at an odd subband of an odd subframe or at an even subband of an even subframe; or

the terminal-specific high layer signaling indicates the location of the RB occupied by each interference measurement resource, and indicates the cycle and the subframe offset corresponding to the interference measurement in an indexing way, according as the preset location of each interference measure resource is at an odd RB of an odd subframe, or at an even RB of an even subframe.

Here, the location of the interference measurement resource at least includes one of the followings: the location of the RB occupied by the interference measurement resource, the location of the subband occupied by the interference measurement resource, the time frequency location of the interference measurement resource in one RB, and the subframe location and the cycle of the interference measurement resource.

The base station side 21 further includes a notifying module 213, which is configured to notify the terminal side 22 through a preset way and/or a terminal-specific high layer signaling that a hopping way is employed to determine the location of the interference measurement resource, and to notify the terminal side 22 of the employed hopping way; or

the notifying module 213 is configured to notify the terminal of the location of a physical RB pair in which the interference measurement resource is located, through RB indication information in a downlink authorization signaling.

Based on the above system, the embodiment of the disclosure also provides a terminal side 22, as shown in FIG. 1, which includes a location determining module 221 and an interference measurement module 222; wherein

the location determining module 221 is configured to receive a location indication signaling of each set of interference measurement resources sent by a base station side, and to determine a location of each set of the interference measurement resources according to the location indication signaling of each set of the interference measurement resources;

the interference measurement module 222 is configured to perform interference measurement on each set of the interference measurement resources according as a non-full bandwidth or a full bandwidth;

the location indication signaling includes a location identifier; and

the location identifier includes a location identifier of a location of a subband, or a location identifier of a location of a RBG, or a location identifier of a location of a RB occupied by each set of the interference measurement resources.

The location determining module 221 is further configured to determine the location of each set of the interference measurement resources based on the location identifier and at least one of the following configuration information: a system bandwidth configuration, a number of the RBs contained in the RBG, the number of the RBs contained in the subband, a transmission mode configuration, a feedback mode configuration, and a feedback type configuration

The location determining module 221 is specifically configured to determine a reuse factor of the interference measurement resource according to the system bandwidth configuration, and to determine the location of the RB occupied by each set of the interference measurement resources based on the reuse factor and the location identifier in the location indication signaling.

The location determining module 221 is specifically configured to determine the number of the RBs that can be occupied in one RBG by the interference measurement resource according to the system bandwidth configuration and the number of the RBs contained in the RBG, and to determine the location of the RB occupied by each set of the interference measurement resources based on the number of the RBs and the location identifier in the location indication signaling.

The location determine module 221 is specifically configured to determine the number of the RBs that can be occupied in one subband by the interference measurement resource according to the system bandwidth configuration and the number of the RBs contained in the subband, and to determine the location of the RB occupied by each set of the interference measurement resources based on the number of the RBs and the location identifier in the location indication signaling.

The location determining module 221 is specifically configured to determine a distributing way of the interference measurement resource according to the transmission mode configuration, and/or the feedback mode configuration, and/or the feedback type configuration, and to determine the location of the RB occupied by each set of the interference measurement resources based on the distributing way and the location identifier.

The location indication signaling is a terminal-specific high layer signaling, the location determining module 221 is configured to determine the location of each set of the interference measurement resources in accordance with an indication of the terminal-specific high layer signaling.

The indication of the terminal-specific high layer signaling includes:

indicating the location of the RB occupied by each set of the interference measurement resources in a bitmapping way, and indicating a cycle and a subframe offset corresponding to the interference measurement in an indexing way;

or indicating the location of the RB occupied by each set of the interference measurement resources in a resource distributing way of a resource distributing type 0, a resource distributing type 1, or a resource distributing type 2, and indicating the cycle and the subframe offset corresponding to the interference measurement in an indexing way;

or indicating the location of the subband occupied by each set of the interference measurement resources in a bitmapping way, and indicating the cycle and the subframe offset corresponding to the interference measurement in an indexing way;

or indicating the location of the subband occupied by each set of the interference measurement resources in a resource distributing way of the resource distributing type 0, the resource distributing type 1, or the resource distributing type 2, and indicating the cycle and the subframe offset corresponding to the interference measurement in an indexing way;

or indicating the location of the RB occupied by each interference measurement resource, and indicating the cycle and the subframe offset corresponding to the interference measurement in an indexing way, according as the preset location of each interference measurement resource is at an odd RB or at an even RB;

or indicating the location of the subband occupied by each interference measurement resource, and indicating the cycle and the subframe offset corresponding to the interference measurement in an indexing way, according as the preset location of each interference measure resource is at an odd subband or at an even subband;

or indicating the location of the subband occupied by each interference measurement resource, and indicating the cycle and the subframe offset corresponding to the interference measurement in an indexing way, according as the preset location of each interference measure resource is at an odd subband of an odd subframe, or at an even subband of an even subframe;

or indicating the location of the RB occupied by each interference measurement resource, and indicating the cycle and the subframe offset corresponding to the interference measurement in an indexing way, according as the preset location of each interference measure resource is at an odd RB of an odd subframe, or at an even RB of an even subframe.

Here, the location of the interference measurement resource at least includes one of the followings: the location of the RB occupied by the interference measurement resource, the location of the subband occupied by the interference measurement resource, a time frequency location of the interference measurement resource in one RB, and a subframe location and the cycle of the interference measurement resource.

The location determining module 221 is further configured to search out the interference measurement resource by a hopping way notified by a base station side; or the location determining module 221 is further configured to obtain the location of a physical RB pair in which the interference measurement resource is located, by detecting RB indication information in a downlink authorization signaling.

An implementing process and a principle of the method according to the embodiment of the disclosure are described in detail below in combination with the specific embodiment.

### Embodiment 1

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; the location indication signaling is a terminal-specific high layer signaling; the terminal-specific high layer signaling indicates the location of the RB occupied by each set of the interference measurement resources in a bitmapping way, or the terminal-specific high layer signaling indicates the location of the RB occupied in one corresponding subframe by each set of the interference measurement resources in a resource distributing way of the resource distributing type 1, the resource distributing type 1, or the resource distributing type 2.

The UE1 determines the location of each set of the interference measurement resources, which includes the subframe location and a frequency domain location, according to the terminal-specific high layer signaling, and performs the interference measurement on each set of the interference measurement resources according as the non-full bandwidth or the full bandwidth.

### Embodiment 2

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; the location indication signaling is a terminal-specific high layer signaling; the terminal-specific high layer signaling indicates that the location of the RB occupied in one subframe by each set of the interference measurement resources is at an odd RB or even RB, according as the preset location of each interference measurement resource is at an odd RB or even RB.

the UE1 determines the location of the interference measurement resource, which includes the subframe location and the frequency domain location, according to the terminal-specific high layer signaling, and performs the interference measurement on each the interference measurement resource according as the non-full bandwidth or the full bandwidth.

### Embodiment 3

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; the location indication signaling is a terminal-specific high layer signaling; the terminal-specific high layer signaling indicates the location of the subband occupied by each set of the interference measurement resources in a bitmapping way; or the terminal-specific high layer signaling indicates the location of the subband occupied in one corresponding subframe by each set of the interference measurement resources in the resource distributing way of the resource distributing type 1, the resource distributing type 1, or the resource distributing type 2.

The UE1 determines the location of each set of the interference measurement resources, which includes the subframe location and the frequency domain location, according to the terminal-specific high layer signaling, and performs the interference measurement on each set of the interference measurement resources according as the non-full bandwidth or the full bandwidth.

### Embodiment 4

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; the location indication signaling is a terminal-specific high layer signaling; the terminal-specific high layer signaling indicates that the location of the subband occupied by each set of the interference measurement resources is an odd subband or even subband, according as the preset location of each set of the interference measurement resources is at an odd subband or even subband.

The UE1 determines the location of each set of the interference measurement resources according to the terminal-specific high layer signaling, and performs the interference measurement on each set of the interference measurement resources according as the non-full bandwidth or the full bandwidth.

### Embodiment 5

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; the location indication signaling includes the location identifier indicating the location of the RB occupied by each set of the interference measurement resources, and the system bandwidth configuration. The base station selects the location identifier corresponding to the size of a reuse facture to indicate the location of the RB occupied by the interference measurement resource, according to a corresponding relationship between the system bandwidth and the reuse factor of the Interference Measurement Resource (IMR) which is shown in Table 4.

| System Bandwidth | IMR Reuse Factor |
|---|---|
| N_{RB}^{DL} | (k) |
| 6-7 | S1 |
| 8-10 | S2 |
| 11-26 | S3 |
| 27-63 | S4 |
| 64-110 | S5 |

In Table 4, when the system bandwidth is N_{RB}^{DL}, the corresponding reuse factor is Sx (x=1,2,3,4,5), the full bandwidth may have Sx RB locations of interference measurement resources, and each of interference measurement resources occupies N_{RB}^{DL}/Sx RBs.

For example, when the reuse factor is Sx=2, the base station side selects 1 bit to indicate the location of the RB of the interference measurement resource in the full bandwidth, wherein 0 indicates the interference measurement resource is located at an odd RB in the full bandwidth, and 1 indicates the interference measurement resource is located at an even RB in the full bandwidth.

Also, for example, when the reuse factor is Sx=3, the base station selects 2 bits to indicates the location of the RB of the configured interference measurement resource in the full bandwidth, wherein 00 indicates the interference measurement resource is located at a 3n−1 RB in the full bandwidth, 01 indicates the interference measurement resource is located at a 3n+2 RB in the full bandwidth, 10 indicates the interference measurement resource is located at a 3n+3 RB in the full bandwidth, and 11 indicates the interference measurement resource is located at all RBs in the full bandwidth.

The UE1 determines the location of each set of the interference measurement resources according to the system bandwidth configuration and the location identifier, and performs the interference measurement on each set of the interference measurement resources according as the non-full bandwidth or the full bandwidth.

### Embodiment 6

In this embodiment, it is supposed that UE1 is R12 or a user of higher version, the base station sends N sets of interference measurement resources on a non-full bandwidth or a full bandwidth, and sends the location indication signaling of each set of the interference measurement resources to the UE1; the location indication signaling includes the location identifier indicating the location of the RB occupied by each set of the interference measurement resources, the system bandwidth configuration, and the number of the RBs contained in the subband. The base station selects a location identifier corresponding to the number of the RBs to indicate the location of the RB occupied by the interference measurement resource, according to the corresponding relationship among the system bandwidth configuration, the number of the RBs contained in the subband, and the number of the RBs that can be occupied in one subband by the interference measurement resource, which is shown in Table 5.

TABLE 5

| | Number of RBs | Number of RBs that can be |
|---|---|---|
| System Bandwidth | contained in | occupied in one subband by |
| N_{RB}^{DL} | subband | interference measurement resource |
| 6-7 | N1 | S1 |
| 8-10 | N2 | S2 |
| 11-26 | N3 | S3 |
| 27-63 | N4 | S4 |
| 64-110 | N5 | S5 |

In Table 5, when the system bandwidth is N_{RB}^{DL}, the number of the RBs contained in the corresponding subband is N; each subband can be divided into Sx RB locations of interference measurement resources; each interference measurement resource occupies N_{RB}^{DL}/N*Sx RBs.

For example, when N_{RB}^{DL}=10, each subband can be divided into 2 RB locations of the interference measurement resources, for example, corresponding interference measurement resources may be configured at the 1 RB location and 3 RB location in each subband.

When one subband includes 2 RB locations of the interference measurement resources, the base station selects 1 bit to indicate the RB location of the configured interference measurement resources in each subband; wherein 0 indicates that the interference measurement resource is located at an odd RB in one subband, and 1 indicates that the interference measurement resource is located at an even RB in one subband.

The UE1 determines the location of each set of the interference measurement resources according to the system bandwidth configuration, the number of the RBs contained in the subband and the location identifier, and performs the interference measurement on each set of the interference measurement resources according as the non-full bandwidth or the full bandwidth.

### Embodiment 7

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; the location indication signaling includes the location identifier indicating the location of the RB occupied by each set of the interference measurement resources, the system bandwidth configuration, and the number of the RBs contained in the RBG. The base station selects the location identifier corresponding to the number of the RBs to indicate the location of the RB occupied by the interference measurement resource, according to the corresponding relationship among the system bandwidth configuration, the number of the RBs contained in the RBG, and the number of the RBs that can be occupied in one RBG by the interference measurement resource, which is shown in Table 6.

TABLE 6

| | Number | Number of RBs that can be occupied in |
|---|---|---|
| | of RBs | one RBG by interference |
| System Bandwidth | contained | measurement resource |
| N_{RB}^{DL} | in RBG | (P) |
| ≦0 | 1 | S1 |
| 11-26 | 2 | S2 |
| 27-63 | 3 | S3 |
| 64-110 | 4 | S4 |

In Table 6, when the system bandwidth is N_{RB}^{DL}, the number of the RBs contained in the corresponding RBG is N (N=1,2,3,4); each RBG can be divided into Sx (x=1,2,3,4) RB locations of the interference measurement resources; each interference measurement resource occupies N_{RB}^{DL}/N*Sx RBs.

For example, when N_{RB}^{DL}=20, each RBG can be divided into 2 RB locations of the interference measurement resources, and one RBG contains 2 RBs; at this moments, 1 RB in each RBG may be configured with a corresponding interference measurement resource.

When one RBG includes 2 RB locations of the interference measurement resources, the base station selects 1 bit to indicate the RB location of the configured interference measurement resource in each RBG, wherein 0 indicates that the interference measurement resource is located at an odd RB in one RBG, and 1 indicates that the interference measurement resource is located at an even RB in one RBG.

The UE1 determines the location of each set of the interference measurement resources according to the system bandwidth configuration, the number of the RBs contained in the RBG and the location identifier, and performs the interference measurement on each set of the interference measurement resources according as the non-full bandwidth or the full bandwidth.

### Embodiment 8

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; besides the location identifier indicating the location of the RB occupied by each set of the interference measurement resources, the location indication signaling further includes a transmission mode configuration and/or a feedback mode configuration and/or a feedback type configuration. The base station indicates a distributing way of the corresponding interference measurement resource according to the transmission mode configuration and/or the feedback mode configuration and/or the feedback type configuration, and selects a location identifier corresponding to the distributing way to identify the location of the RB occupied by each set of the interference measurement resources.

The UE1 determines the location of each set of the interference measurement resources according to the preset transmission mode configuration and/or the feedback mode configuration and/or the feedback type configuration, and performs the interference measurement on each set of the interference measurement resources according as the non-full bandwidth or the full bandwidth.

When the location indication signaling sent by the base station does not includes the location identifier indicating the location of the RB occupied by each set of the interference measurement resources, the UE1 performs interference measurement supposing that the corresponding interference measurement resource exists in the full bandwidth.

### Embodiment 9

In this embodiment, it is supposed that UE1 is R12 or a user of higher version, a base station sends N sets of interference measurement resources on a non-full bandwidth or a full bandwidth, and sends the location indication signaling of each set of the interference measurement resources to the UE1; the location indication signaling is a terminal-specific high layer signaling, and the terminal-specific high layer signaling indicates the location of the subband occupied by each interference measurement resource according as the location of each interference measurement resource is at an odd subband of an odd subframe or at an even subband of an even subframe.

The UE1 determines the location of each set of the interference measurement resources according to the terminal-specific high layer signaling, and performs the interference measurement on each set of the interference measurement resources according as the non-full bandwidth or the full bandwidth.

### Embodiment 10

In this embodiment, it is supposed that UE1 is R12 or a user of higher version, abase station sends N sets of interference measurement resources on the non-full bandwidth or the full bandwidth, and sends the location indication signaling of each set of the interference measurement resources to the UE1; the location indication signaling is a terminal-specific high layer signaling, and the terminal-specific high layer signaling indicates the location of the RB occupied by each interference measurement resource, according as the location of each interference measurement resource is at an odd RB of an odd subframe or at an even RB of an even subframe.

The UE1 determines the location of each set of the interference measurement resources according to the terminal-specific high layer signaling, and performs the interference measurement on each set of the interference measurement resources according as the non-full bandwidth or the full bandwidth.

### Embodiment 11

In this embodiment, it is supposed that UE1 is R12 or a user of higher version, a base station notifies the UE1 by a presetting or a high layer signaling that the full bandwidth can be divided into 4 RB locations of the interference measurement resources, and notifies the UE1 through pre-definition or a high layer signaling that the employed hopping way is 4n−1, 4n+2, 4n+3, 4n+4, and etc. For example, when the interference measurement resource exists at a 4n−1 subframe, or at a 4n−1 RB of a 4n−1 system frame, the hopping way is 4n+1; when the interference measurement resource exists at a 4n+2 subframe, or at a 4n+2 RB of a 4n+2 system frame, the hopping way is 4n+2; when the interference measurement resource exists at a 4n+3 subframe, or at a 4n+3 RB of a 4n+3 system frame, the hopping way is 4n+3; when the interference measurement resource exists at a 4n+4 subframe, or at a 4n+4 RB of a 4n+4 system frame, the hopping way is 4n+4.

The UE1 receives the interference measurement resource distributed by the base station, and performs the interference measurement on the 4n−1 subframe, or on the 4n−1 RB of the 4n−1 system frame, or performs the interference measurement on the 4n+2 subframe, or on the 4n+2 RB of the 4n+2 system frame, or performs the interference measurement on the 4n+3 subframe, or on the 4n+3 RB of the 4n+3 system frame, or performs the interference measurement on the 4n+4 subframe, or on the 4n+4 RB of the 4n+4 system frame.

### Embodiment 12

In this embodiment, it is supposed that the terminal is R12 or a user of higher version, a base station notifies the terminal of the resource location of the PDSCH through RB indication information in a downlink authentication signaling, and at the same time the base station notifies the terminal of the location of PRB Pairs in which the interference measurement resource is located.

The terminal obtains the resource location of the PDSCH by detecting the RB indication information in the downlink authentication signaling, and at the same time the terminal side obtains the location of the PRB Pairs in which the interference measurement resource is located by receiving the RB indication information.

### INDUSTRIAL APPLICABILITY

In the embodiment of the disclosure, a base station side transmits N sets of interference measurement resources on a non-full bandwidth or a full bandwidth, and transmits the location indication signaling of each set of the interference measurement resources to the terminal side; the terminal side determines the location of each set of the interference measurement resources according to the location indication signaling of each set of interference measurement resources, and performs interference measurement according as the non-full bandwidth or the full bandwidth. In this way, the interference measurement can be implemented on different interference measurement resources by employing time and frequency domain resource overheads and high layer signaling overheads as less as possible.

All those described above are only preferred embodiments of the disclosure, and are not used to limit the protection scope of the disclosure.

What is claimed is:

1. A method for performing interference measurement on interference measurement resources, comprising:
transmitting, by a base station side, N sets of interference measurement resources on a non-full bandwidth or a full bandwidth, and transmitting a location indication signaling of each set of the interference measurement resources to a terminal side;
wherein the location indication signaling comprises a location identifier, and the location identifier comprises a location identifier of a location of a subband, or a location identifier of a location of a Resource Block Group (RBG), or a location identifier of a location of a Resource Block (RB) occupied by each set of the interference measurement resources.

2. (canceled)

3. The method according to claim 1, further comprising: before the base station side transmits the N sets of interference measurement resources on the non-full bandwidth or the full bandwidth,
determining, by the base station, the location identifier, according to at least one of the following configuration information: a system bandwidth configuration, the number of RBs contained in the RBG, the number of RBs contained in the subband, a transmission mode configuration, a feedback mode configuration, and a feedback type configuration, and determining a location of each set of the interference measurement resources based on the location identifier and at least one of the configuration information; wherein
the system bandwidth configuration, and/or the number of the RBs contained in the RBG, and/or the number of the RBs contained in the subband, and/or the transmission mode configuration, and/or the feedback mode configuration, and/or the feedback type configuration are notified to the terminal side through a system configuration or a predefined way.

4. The method according to claim 1, wherein the location indication signaling also comprises at least one of following configuration information: a system bandwidth configuration, the number of RBs contained in the RBG, the number of RBs contained in the subband, a transmission mode configuration, a feedback mode configuration, and a feedback type configuration.

5. The method according to claim 3, wherein the location of each set of the interference measurement resources is determined by one of following ways:
determining, by the base station side, a reuse factor of the interference measurement resources according to the system bandwidth configuration, and determining the location of the RB occupied by each set of the interference measurement resources based on the reuse factor and the location identifier;
determining, by the base station side, the number of RBs occupied in one RBG by the interference measurement resources according to the system bandwidth configuration and the number of the RBs contained in the RBG, and determining the location of the RB occupied by each set of the interference measurement resources based on the number of the RBs and the location identifier;
determining, by the base station side, the number of RBs occupied in one subband by the interference measurement resources according to the system bandwidth configuration and the number of the RBs contained in the subband, and determining the location of the RB occupied by each set of the interference measurement resources based on the number of the RBs and the location identifier; and
determining, by the base station side, a distribution way of the interference measurement resources according to the transmission mode configuration, and/or the feedback mode configuration, and/or the feedback type configuration, and determining the location of the RB occupied by each set of the interference measurement resources based on the distribution way and the location identifier.

6-8. (canceled)

9. The method according to claim 1, wherein the location indication signaling is a terminal-specific high layer signaling; and indicating, by the terminal-specific high layer signaling, a location of each set of the interference measurement resources, comprises:
indicating, by the terminal-specific high layer signaling, a location of a RB occupied by each set of the interference measurement resources in a bitmapping way, and indicating a cycle and a subframe offset corresponding to the interference measurement in an indexing way;
or indicating, by the terminal-specific high layer signaling, the location of the RB occupied by each set of the interference measurement resources in a resource distributing way of resource distributing type 0, resource distributing type 1, or resource distributing type 2, and indicating the cycle and the subframe offset corresponding to the interference measurement in the indexing way;
or indicating, by the terminal-specific high layer signaling, a location of a subband occupied by each set of the interference measurement resources in the bitmapping way, and indicating the cycle and the subframe offset corresponding to the interference measurement in the indexing way;
or indicating, by the terminal-specific high layer signaling, the location of the subband occupied by each set of the interference measurement resources in the resource distributing way of the resource distributing type 0, the resource distributing type 1, or the resource distributing type 2, and indicating the cycle and the subframe offset corresponding to the interference measurement in the indexing way;
or indicating, by the terminal-specific high layer signaling, the location of the RB occupied by each set of the interference measurement resources, and indicating the cycle and the subframe offset corresponding to the interference measurement in the indexing way, according as a preset location of each set of the interference measurement resources is at an odd RB or at an even RB;
or indicating, by the terminal-specific high layer signaling, the location of the subband occupied by each interference measurement resource, and indicating the cycle and the subframe offset corresponding to the interference measurement in the indexing way, according as the preset location of each set of the interference measure resources is at an odd subband or at an even subband;
or indicating, by the terminal-specific high layer signaling, the location of the subband occupied by each set of the interference measurement resources, and indicating the cycle and the subframe offset corresponding to the interference measurement in the indexing way, according as the preset location of each interference measure resource is at an odd subband of an odd subframe, or at an even subband of an even subframe;
or indicating, by the terminal-specific high layer signaling, the location of the RB occupied by each set of the interference measurement resources, and indicating the cycle and the subframe offset corresponding to the interference measurement in the indexing way, according as the preset location of each interference measure resource is at an odd RB of an odd subframe, or at an even RB of an even subframe.

10. The method according to claim 3, wherein the locations of the interference measurement resources at least comprise one of followings: locations of RBs occupied by the interference measurement resources, locations of subbands occupied by the interference measurement resources, time frequency locations of the interference measurement resources in one RB, and subframe locations and cycles of the interference measurement resources.

11. The method according to claim 1, further comprising: notifying, by the base station side, the terminal side through a preset way and/or a terminal-specific high layer signaling that a hopping way is employed to determine locations of the interference measurement resources, and notifying the terminal side of the hopping way employed; or
notifying, by the base station side, the terminal side of a location of a physical RB pair in which the interference measurement resources are located, through RB indication information in a downlink authorization signaling.

12. A method for performing interference measurement on interference measurement resources, comprising:
receiving, by a terminal side, a location indication signaling of each set of interference measurement resources transmitted by a base station side, determining a location of each set of the interference measurement resources according to the location indication signaling of each set of interference measurement resources, and performing interference measurement on each set of interference measurement resources according as a non-full bandwidth or a full bandwidth;
wherein the location indication signaling comprises a location identifier, and the location identifier comprises a location identifier of a location of a subband, or a location identifier of a location of a Resource Block Group (RBG), or a location identifier of a location of a Resource Block (RB) occupied by each set of the interference measurement resources.

13. (canceled)

14. The method according to claim 12, wherein determining, by the terminal side, the location of each set of the interference measurement resources comprises one of following ways:
determining, by the terminal side, the location of each set of the interference measurement resources based on the location identifier and at least one of the following configuration information: a system bandwidth configuration, the number of RBs contained in the RBG, the number of RBs contained in the subband, a transmission mode configuration, a feedback mode configuration, and a feedback type configuration; wherein the system bandwidth configuration, and/or the number of the RBs contained in the RBG, and/or the number of the RBs contained in the subband, and/or the transmission mode configuration, and/or the feedback mode configuration, and/or the feedback type configuration are obtained by the terminal side through a system configuration or a predetermined way;
determining, by the terminal side, a reuse factor of the interference measurement resources according to the system bandwidth configuration, and determining the location of the RB occupied by each set of the interference measurement resources based on the reuse factor and the location identifier in the location indication signaling;
determining, by the terminal side, the number of RBs occupied in one RBG by the interference measurement resources according to the system bandwidth configuration and the number of the RBs contained in the RBG, and determining the location of the RB occupied by each set of the interference measurement resources based on the number of the RBs and the location identifier in the location indication signaling;
determining, by the terminal side, the number of RBs occupied in one subband by the interference measurement resources according to the system bandwidth configuration and the number of the RBs contained in the subband, and determining the location of the RB occupied by each set of the interference measurement resources based on the number of the RBs and the location identifier in the location indication signaling;
determining, by the terminal side, a distribution way of the interference measurement resources according to the transmission mode configuration and/or the feedback mode configuration and/or the feedback type configuration, and determining the location of the RB occupied by each set of the interference measurement resources based on the distribution way and the location identifier.

15. The method according to claim 12, wherein the location indication signaling also comprises at least one of following configuration information: a system bandwidth configuration, the number of RBs contained in the RBG, the number of RBs contained in the subband, a transmission mode configuration, a feedback mode configuration, and a feedback type configuration.

16-19. (canceled)

20. The method according to claim 12, wherein the location indication signaling is a terminal-specific high layer signaling, and the terminal side determines the location of each set of the interference measurement resources in accordance with an indication of the terminal-specific high layer signaling;
the indication of the terminal-specific high layer signaling comprises:
indicating a location of a RB occupied by each set of the interference measurement resources in a bitmapping way, and indicating a cycle and a subframe offset corresponding to the interference measurement in an indexing way;
or indicating the location of the RB occupied by each set of the interference measurement resources in a resource distributing way of resource distributing type 0, resource distributing type 1, or resource distributing type 2, and indicating the cycle and the subframe offset corresponding to the interference measurement in the indexing way;
or indicating a location of a subband occupied by each set of the interference measurement resources in the bitmapping way, and indicating the cycle and the subframe offset corresponding to the interference measurement in the indexing way;
or indicating the location of the subband occupied by each set of the interference measurement resources in the resource distributing way of the resource distributing type 0, the resource distributing type 1, or the resource distributing type 2, and indicating the cycle and the subframe offset corresponding to the interference measurement in the indexing way;
or indicating the location of the RB occupied by each set of the interference measurement resources, and indicating the cycle and the subframe offset corresponding to the interference measurement in the indexing way, according as a preset location of each set of the interference measurements resource is at an odd RB or at an even RB;
or indicating the location of the subband occupied by each interference measurement resource, and indicating the cycle and the subframe offset corresponding to the interference measurement in the indexing way, according as the preset location of each set of the interference measure resources is at an odd subband or at an even subband;
or indicating the location of the subband occupied by each set of the interference measurement resources, and indicating the cycle and the subframe offset corresponding to the interference measurement in the indexing way, according as the preset location of each set of the interference measure resources is at an odd subband of an odd subframe, or at an even subband of an even subframe;
or indicating the location of the RB occupied by each set of the interference measurement resources, and indicating the cycle and the subframe offset corresponding to the interference measurement in the indexing way, according as the preset location of each set of the interference measure resources is at an odd RB of an odd subframe, or at an even RB of an even subframe.

21. The method according to claim 12, wherein the locations of the interference measurement resources at least comprise one of followings: locations of RBs occupied by the interference measurement resources, locations of subbands occupied by the interference measurement resources, time frequency locations of the interference measurement resources in one RB, and subframe locations and cycles of the interference measurement resources.

22. The method according to claim 12, further comprising: learning, by the terminal side, that a hopping way is employed to determine the locations of the interference measurement resources and the employed hopping way through a preset way and/or by receiving a terminal-specific high layer signaling, and searching out, by the terminal side, the interference measurement resources in accordance with the hopping way, and performing the interference measurement on the interference measurement resources; or
obtaining, by the terminal side, a location of a physical RB pair in which the interference measurement resources are located, through RB indication information in a downlink authorization signaling.

23. A base station side comprising an interference measurement resource transmitting module and a location indication signaling transmitting module; wherein
the interference measurement resource transmitting module is configured to transmit N sets of interference measurement resources on a non-full bandwidth or a full bandwidth; and
the location indication signaling transmitting module is configured to transmit a location indication signaling of each set of interference measurement resources to a terminal side;
wherein the location indication signaling comprises a location identifier, and the location identifier comprises a location identifier of a location of a subband, or a location identifier of a location of a Resource Block Group (RBG), or a location identifier of a location of a Resource Block (RB) occupied by each set of the interference measurement resources.

24. (canceled)

25. The base station side according to claim 23, wherein the location indication signaling further comprises at least one of following configuration information: a system bandwidth configuration, the number of RBs contained in the RBG, the number of RBs contained in the subband, a transmission mode configuration, a feedback mode configuration, and a feedback type configuration.

26. The base station side according to claim 23, wherein the interference measurement resource transmitting module is further configured to do one of following operations:
determine the location identifier according to at least one of following configuration information: a system bandwidth configuration, the number of RBs contained in the RBG, the number of RBs contained in the subband, a transmission mode configuration, a feedback mode configuration, and a feedback type configuration, and to determine the location of each set of interference measurement resources based on the location identifier and at least one of the configuration information;
determine a reuse factor of the interference measurement resources according to the system bandwidth configuration, and to determine the location of the RB occupied by each set of the interference measurement resources based on the reuse factor and the location identifier;
determine the number of RBs occupied in one RBG by the interference measurement resources according to the system bandwidth configuration and the number of the RBs contained in the RBG, and to determine the location of the RB occupied by each set of the interference measurement resources based on the number of the RBs and the location identifier;
determine the number of RBs occupied in one subband by the interference measurement resources according to the system bandwidth configuration and the number of the RBs contained in the subband, and to determine the location of the RB occupied by each set of the interference measurement resources based on the number of the RBs and the location identifier; and
determine a distribution way of the interference measurement resources according to the transmission mode configuration, and/or the feedback mode configuration, and/or the feedback type configuration, and to determine the location of the RB occupied by each set of the interference measurement resources based on the distribution way and the location identifier.

27-30. (canceled)

31. The base station side according to claim 23, wherein the location indication signaling is a terminal-specific high layer signaling, and indicating, by the terminal-specific high layer signaling, a location of each set of the interference measurement resources, comprises:
indicating, by the terminal-specific high layer signaling, a location of a RB occupied by each set of the interference measurement resources in a bitmapping way, and indicating a cycle and a subframe offset corresponding to the interference measurement in an indexing way;
or indicating, by the terminal-specific high layer signaling, the location of the RB occupied by each set of the interference measurement resources in a resource distributing way of resource distributing type 0, resource distributing type 1, or resource distributing type 2, and indicating the cycle and the subframe offset corresponding to the interference measurement in the indexing way;
or indicating, by the terminal-specific high layer signaling, a location of a subband occupied by each set of the interference measurement resources in the bitmapping way, and indicating the cycle and the subframe offset corresponding to the interference measurement in the indexing way;
or indicating, by the terminal-specific high layer signaling, the location of the subband occupied by each set of the interference measurement resources in the resource distributing way of the resource distributing type 0, the resource distributing type 1, or the resource distributing type 2, and indicating the cycle and the subframe offset corresponding to the interference measurement in the indexing way;
or indicating, by the terminal-specific high layer signaling, the location of the RB occupied by each set of the interference measurement resources, and indicating the cycle and the subframe offset corresponding to the interference measurement in the indexing way, according as a preset location of each set of the interference measurement resources is at an odd RB or at an even RB;
or indicating, by the terminal-specific high layer signaling, the location of the subband occupied by each interference measurement resource, and indicating the cycle and the subframe offset corresponding to the interference measurement in the indexing way, according as the preset location of each set of the interference measure resources is at an odd subband or at an even subband;
or indicating, by the terminal-specific high layer signaling, the location of the subband occupied by each interference measurement resource, and indicating the cycle and the subframe offset corresponding to the interference measurement in the indexing way, according as the preset location of each set of the interference measure resources is at an odd subband of an odd subframe, or at an even subband of an even subframe;
or indicating, by the terminal-specific high layer signaling, the location of the RB occupied by each set of the interference measurement resources, and indicating the cycle and the subframe offset corresponding to the interference measurement in the indexing way, according as the preset location of each interference measure resource is at an odd RB of an odd subframe, or at an even RB of an even subframe.

32. The base station side according to claim 23, wherein the base station side further comprises a notifying module, which is configured to notify the terminal side through a preset way and/or a terminal-specific high layer signaling that a hopping way is employed to determine locations of the interference measurement resources, and to notify the terminal side of the hopping way employed; or
the notifying module configured to notify the terminal side of a location of a physical RB pair in which the interference measurement resources are located, through RB indication information in a downlink authorization signaling.

33. A terminal side, comprising a location determining module and an interference measurement module; wherein
the location determining module is configured to receive a location indication signaling of each set of interference measurement resources sent by a base station side, and to determine a location of each set of the interference measurement resources according to the location indication signaling of each set of the interference measurement resources; and
the interference measurement module is configured to perform interference measurement on each set of the interference measurement resources according as a non-full bandwidth or a full bandwidth;
wherein the location indication signaling comprises a location identifier, and the location identifier comprises a location identifier of a location of a subband, or a location identifier of a location of a Resource Block Group (RBG), or a location identifier of a location of a Resource Block (RB) occupied by each set of the interference measurement resources.

34. (canceled)

35. The terminal side according to claim 33, wherein the location determining module is further configured to do one of following operations:
determine the location of each set of the interference measurement resources based on the location identifier and at least one of following configuration information: a system bandwidth configuration, the number of RBs contained in the RBG, the number of RBs contained in the subband, a transmission mode configuration, a feedback mode configuration, and a feedback type configuration.
determine a reuse factor of the interference measurement resources according to the system bandwidth configuration, and to determine the location of the RB occupied by each set of the interference measurement resources based on the reuse factor and the location identifier in the location indication signaling.
determine the number of RBs occupied in one RBG by the interference measurement resources according to the system bandwidth configuration and the number of the RBs contained in the RBG, and to determine the location of the RB occupied by each set of the interference measurement resources based on the number of the RBs and the location identifier in the location indication signaling.
determine the number of RBs occupied in one subband by the interference measurement resource according to the system bandwidth configuration and the number of the RBs contained in the subband, and to determine the location of the RB occupied by each set of the interference measurement resources based on the number of the RBs and the location identifier in the location indication signaling.
determine a distributing way of the interference measurement resources according to the transmission mode configuration, and/or the feedback mode configuration, and/or the feedback type configuration, and to determine the location of the RB occupied by each set of the interference measurement resources based on the distributing way and the location identifier.

36-39. (canceled)

40. The terminal side according to claim 33, wherein the location indication signaling is a terminal-specific high layer signaling, the location determining module is configured to determine the location of each set of the interference measurement resources in accordance with an indication of the terminal-specific high layer signaling;
the indication of the terminal-specific high layer signaling comprises:
indicating a location of a RB occupied by each set of the interference measurement resources in a bitmapping way, and indicating a cycle and a subframe offset corresponding to the interference measurement in an indexing way;
or indicating the location of the RB occupied by each set of the interference measurement resources in a resource distributing way of resource distributing type 0, resource distributing type 1, or resource distributing type 2, and indicating the cycle and the subframe offset corresponding to the interference measurement in the indexing way;
or indicating a location of a subband occupied by each set of the interference measurement resources in the bitmapping way, and indicating the cycle and the subframe offset corresponding to the interference measurement in the indexing way;
or indicating the location of the subband occupied by each set of the interference measurement resources in the resource distributing way of the resource distributing type 0, the resource distributing type 1, or the resource distributing type 2, and indicating the cycle and the subframe offset corresponding to the interference measurement in the indexing way;
or indicating the location of the RB occupied by each set of the interference measurement resources, and indicating the cycle and the subframe offset corresponding to the interference measurement in the indexing way, according as a preset location of each set of the interference measurement resources is an at odd RB or at an even RB;
or indicating the location of the subband occupied by each interference measurement resource, and indicating the cycle and the subframe offset corresponding to the interference measurement in the indexing way, according as the preset location of each set of the interference measure resources is at an odd subband or at an even subband;
or indicating the location of the subband occupied by each set of the interference measurement resources, and indicating the cycle and the subframe offset corresponding to the interference measurement in the indexing way, according as the preset location of each set of the interference measure resources is at an odd subband of an odd subframe, or at an even subband of an even subframe;
or indicating the location of the RB occupied by each set of the interference measurement resources, and indicating the cycle and the subframe offset corresponding to the interference measurement in the indexing way, according as the preset location of each set of the interference measure resources is at an odd RB of an odd subframe, or at an even RB of an even subframe.

41. The method according to claim 33, wherein the locations of the interference measurement resources at least comprise one of followings:
locations of RBs occupied by the interference measurement resources, locations of subbands occupied by the interference measurement resources, time frequency locations of the interference measurement resources in one RB, and subframe locations and cycles of the interference measurement resources; and/or
wherein the location determining module is further configured to search out the interference measurement resources in accordance with a hopping way notified by a base station side; or the location determining module is further configured to obtain a location of a physical RB pair in which the interference measurement resources are located, by detecting RB indication information in a downlink authorization signaling.

42. (canceled)
